(19) United States
(12) Patent Application Publication
(10) Pub. No.: US 2025/0211709 A1
(43) Pub. Date: Jun. 26, 2025

(54) ELECTRONIC DEVICE AND CONTROL METHOD THEREFOR

(71) Applicant: Samsung Electronics Co., Ltd., Suwon-si (KR)

(72) Inventors: Woonsung PARK, Suwon-si (KR); Wonseok SONG, Suwon-si (KR); Yoosun JUNG, Suwon-si (KR)

(21) Appl. No.: 19/073,927

(22) Filed: Mar. 7, 2025

Related U.S. Application Data
(63) Continuation of application No. PCT/KR2023/016182, filed on Oct. 18, 2023.

(30) Foreign Application Priority Data
Dec. 5, 2022 (KR) 10-2022-0167765

(51) Int. Cl. H04N 7/01; G06T 7/246

(52) U.S. Cl. CPC H04N 7/0137; G06T 7/248; G06T 2207/10016; G06T 2207/20081

(57) ABSTRACT

An electronic apparatus may include memory storing first and second learning models that have the same network structure and estimate a motion between two frames, a processor configured to obtain a first frame included in an input image and a second frame which is a previous frame of the first frame, and generate an interpolation frame using the obtained first frame and second frame, and the first learning model is a model trained with image data having a first characteristic, the second learning model is a model trained with image data having a second characteristic which is opposite to the first characteristic, and the processor is configured to generate a third learning model using a first control parameter and the first and second learning models, estimate a motion between the first frame and the second frame using the generated third learning model, and generate the interpolation frame based on the estimated motion.

### CROSS-REFERENCE TO RELATED APPLICATIONS

This application is a continuation application of International Application No. PCT/KR2023/016182 designating the United States, filed on Oct. 18, 2023, in the Korean Intellectual Property Receiving Office and claiming priority to Korean Patent Application No. 10-2022-0167765, filed on Dec. 5, 2022, the disclosures of which are all hereby incorporated by reference herein in their entireties.

### BACKGROUND

### Technical Field

Certain example embodiments may relate to an electronic apparatus and/or a controlling method thereof, and for example to an electronic apparatus capable of generating an interpolation frame using two learning models trained relatively to each other and/or a controlling method thereof.

### Background Art

Frame interpolation refers to the process of raising frames of a video or a real-time rendering image. For example, if a display device is capable of running at 120 Hz, but the video has 60 Hz, frame interpolation can be used to significantly reduce screen shake or other phenomena and make the screen appear more natural.

Methods for creating an interpolated image include block-based interpolation techniques, differential-based interpolation techniques, and deep learning-based interpolation techniques and recently, deep learning-based interpolation techniques have been widely used.

### SUMMARY

An electronic apparatus according to an example embodiment may include memory storing first and second learning models that have the same network structure and estimate a motion between two frames, and a processor, comprising processing circuitry, configured to obtain a first frame included in an input image and a second frame which is a previous frame of the first frame, and generate an interpolation frame using the obtained first frame and second frame.

The first learning model, comprising processing circuitry, may be a model trained with image data having a first characteristic, and the second learning model, comprising processing circuitry, may be a model trained with image data having a second characteristic which is opposite to the first characteristic.

The processor may be configured to generate a third learning model, comprising processing circuitry, using a first control parameter and the first and second learning models, estimate a motion between the first frame and the second frame using the generated third learning model, and generate the interpolation frame based on the estimated motion.

A controlling method according to an example embodiment may include storing first and second learning models which have the same network structure and estimate a motion between two frames, obtaining a first frame included in an input image and a second frame which is a previous frame of the first frame, and generating an interpolation frame using the obtained first frame and second frame.

The first learning model may be a model trained with image data having a first characteristic, and the second learning model may be a model trained with image data having a second characteristic which is opposite to the first characteristic.

The generating the interpolation frame may include generating a third learning model using a first control parameter and the first and second learning models, estimating a motion between the first frame and the second frame using the generated third learning model, and generating the interpolation frame based on the estimated motion.

In a non-transitory computer-readable recording medium storing a program for executing a controlling method of an electronic apparatus, the method may include storing first and second learning models which have the same network structure and estimate a motion between two frames, obtaining a first frame included in an input image and a second frame which is a previous frame of the first frame, and generating an interpolation frame using the obtained first frame and second frame.

The first learning model may be a model trained with image data having a first characteristic, and the second learning model may be a model trained with image data having a second characteristic which is opposite to the first characteristic.

The generating the interpolation frame may include generating a third learning model using a first control parameter and the first and second learning models, estimating a motion between the first frame and the second frame using the generated third learning model, and generating the interpolation frame based on the estimated motion.

### DESCRIPTION OF DRAWINGS

Aspects, features, and advantages of specific example embodiments will become apparent from the following description with reference to the accompanying drawings which include:

FIG. 1 is a view provided to explain a frame interpolation operation according to an example embodiment;

FIG. 2 is a block diagram illustrating configuration of an electronic apparatus according to an example embodiment;

FIG. 3 is a block diagram illustrating configuration of an electronic apparatus according to an example embodiment;

FIG. 4 is a view provided to explain a deep learning-based frame interpolation technique according to an example embodiment;

FIG. 5 is a view provided to explain an interpolation operation of a network model according to an example embodiment;

FIG. 6 is a view provided to explain a detailed operation of an interpolation operation of a network model according to an example embodiment;

FIG. 7 is a view illustrating detailed configuration of a processor according to an example embodiment;

FIG. 8 is a view provided to explain a learning operation of a learning model according to an example embodiment;

FIG. 9 is a view provided to explain an operation of adjusting a control parameter in a development process according to an example embodiment;

FIG. 10 is a view provided to explain an operation of adjusting a control parameter in an interpolation process according to an example embodiment; and

FIG. 11 is a view provided to explain a controlling method of an electronic apparatus according to an example embodiment.

### DETAILED DESCRIPTION

Hereinafter, the present disclosure will be described in detail with reference to the accompanying drawings.

General terms that are currently widely used are selected as the terms used in the embodiments of the disclosure in consideration of their functions in the disclosure, but may be changed based on the intention of those skilled in the art or a judicial precedent, the emergence of a new technique, or the like. In addition, in a specific case, terms arbitrarily chosen by an applicant may exist, in which case, the meanings of such terms will be described in detail in the corresponding descriptions of the disclosure. Therefore, the terms used in the embodiments of the disclosure need to be defined on the basis of the meanings of the terms and the overall contents throughout the disclosure rather than simple names of the terms.

In the disclosure, the expressions “have”, “may have”, “include” or “may include” indicate existence of corresponding features (e.g., components such as numeric values, functions, operations, or components), but do not exclude presence of additional features.

The expression “at least one of A and/or B” should be understood to mean either “A” or “B” or “A and B.”

Expressions “first”, “second”, “1st,” “2nd,” or the like, used in the disclosure may indicate various components regardless of sequence and/or importance of the components, will be used only in order to distinguish one component from the other components, and do not limit the corresponding components.

Singular expressions include plural expressions unless the context clearly dictates otherwise. In this specification, terms such as “comprise” or “have” are intended to designate the presence of features, numbers, steps, operations, components, parts, or a combination thereof described in the specification, but are not intended to exclude in advance the possibility of the presence or addition of one or more of other features, numbers, steps, operations, components, parts, or a combination thereof.

In this specification, the term ‘user’ may refer to a person using an electronic apparatus or a device using an electronic apparatus (e.g., an artificial intelligence electronic apparatus).

Hereinafter, an embodiment of the present disclosure will be described in greater detail with reference to the accompanying drawings.

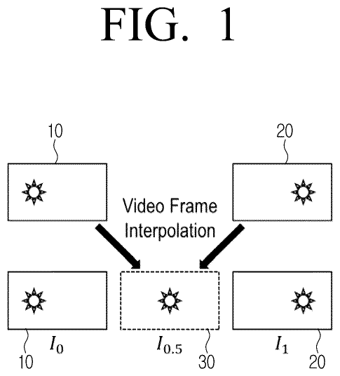

FIG. 1 is a view provided to explain a frame interpolation operation according to an embodiment.

Referring to FIG. 1, a frame interpolation method indicates generating an interpolation frame 30 (or intermediate frame) between each frame 10, 20 to increase the frame rate of a video including consecutive frames.

In order to generate the interpolation frames 30, it is important to accurately estimate a motion between each frame and accurately synthesize the pixels of the intermediate frame based on the estimated motion.

Meanwhile, although the illustrated example shows generating a single interpolation frame 30 between the two frames 10, 20, it is possible in an implementation to generate two or more interpolation frames.

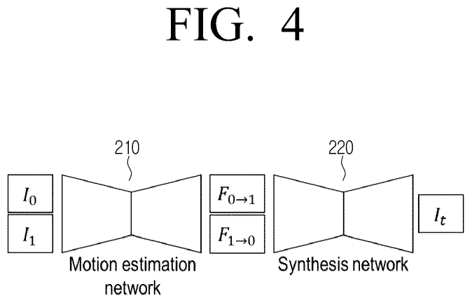

There are many different ways to interpolate these frames. For example, there may be a block-based interpolation technique, a differential-based interpolation technique, a deep learning-based interpolation technique, etc. Recently, AI Video Frame Interpolation (VFI) using AI is being studied most actively. A motion-based AI Frame Interpolation technique according to the present disclosure will be described below with reference to FIGS. 4 to 6.

Meanwhile, the deep learning-based interpolation technique uses a learning model (or an AI model, a deep learning models) trained to perform specific functions. However, when outputting results with the same function but different characteristics, various learning models must be used, or training using data with various characteristics is required. In other words, there was a problem that various learning models were required to perform deep learning-based interpolation adaptively to various characteristics, or that a deep learning model had to be trained using a large number of characteristics.

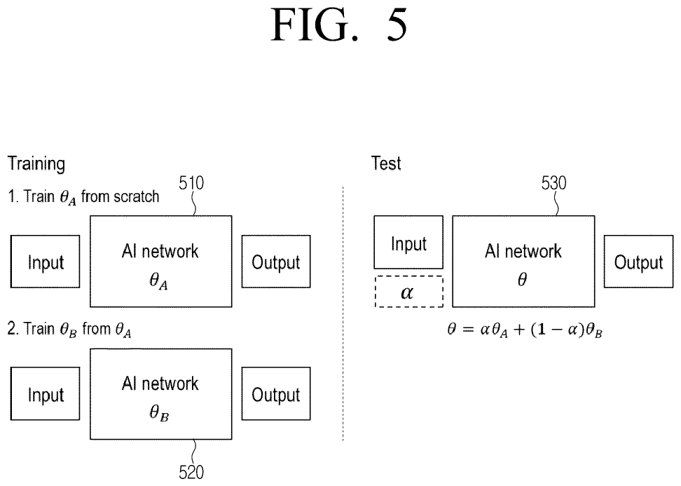

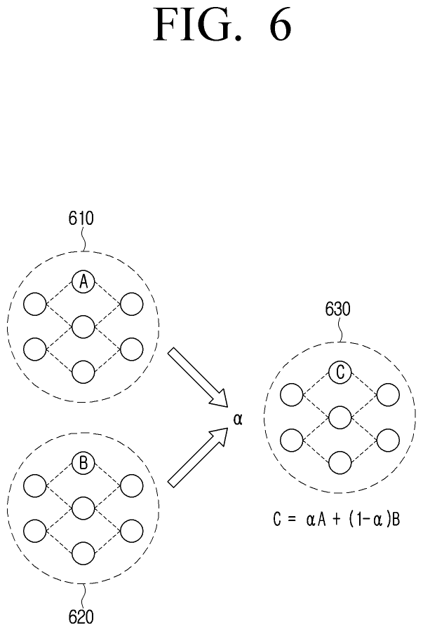

To solve the above problem, the present disclosure uses two learning models that have the same network structure and perform the same function, but are trained with different characteristics (or two learning models trained to have different characteristics). In the above process, when an intermediate characteristic of the two learning models is required, a learning model that combines the two learning models to have such an intermediate characteristic is generated and used. Such an operation will be described below with reference to FIGS. 5 and 6.

For example, it is assumed that a learning model estimating a movement (or motion) of a video within a frame is used. In the prior art case, a learning model needs to be trained using a large number of image data with all cases of motion, including image data with complex movements and image data with simple movements. In this case, not only does the training process take a lot of time, but the generated learning model is also very large.

On the other hand, when using the method according to the present disclosure, two learning models trained with each end of the movements (e.g., complex or simple movements) are used. For example, the first learning model may be trained only using image data with complex movements, and the second learning model may be trained only using image data with the characteristics opposite to the above-described characteristics of the first learning model (e.g., image data with simple movements).

When the image to be interpolated is image data with complex movements, a motion can be estimated using the first learning model described above. Alternatively, when the image to be interpolated is image data with simple movements, a motion can be estimated using the second learning model described above. When the image to be interpolated has movements which are somewhere in between the two cases, the first learning model and the second learning model may be used to perform linear interpolation using a control parameter (e.g., a parameter indicating the degree of simple or complex movements described above, which can have a value between 0 and 1) to generate and use a third learning model having characteristics between the first and second learning models.

Meanwhile, the above-described process uses the first learning model, the second learning model, and the third learning model individually, but if the control parameter has a value of 0, it is the same as using the first learning model and if the control parameter has a value of 1, it is the same as using the second learning model. Therefore, it can be expressed that the third learning model is used in all cases.

In addition, while the above describes the use of linear interpolation of two learning models in the process of estimating the motion of an image, it is also possible to use linear interpolation of two learning models to generate interpolated images with different characteristics in the process of image synthesis. This will be described below with reference to FIGS. 4 to 10.

As such, the present disclosure does not use a learning model that attempts to cover all environments of a characteristic, but rather uses two models trained with characteristics of two extreme ends, and generates a learning model that linearly interpolates the two learning models using a control parameter.

As a result, the training process of the learning model does not require much training to cover all the characteristics, and only two learning models need to be generated using data corresponding to the two extremes of the corresponding characteristic, which makes it possible to train the learning model faster. Furthermore, the generated learning model can be lighter than a prior art learning model because it is trained using only data corresponding to the two extremes of the characteristic.

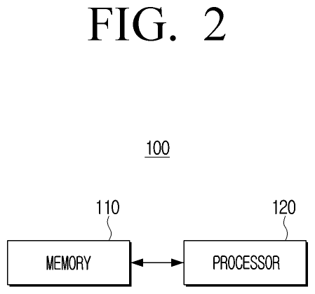

FIG. 2 is a block diagram illustrating configuration of an electronic apparatus according to an embodiment.

Referring to FIG. 2, an electronic apparatus 100 may consist of memory 110 and a processor 120.

The electronic apparatus 100 according to various embodiments may include, for example, at least one of a smart phone, a tablet personal computer (PC), a mobile phone, a video phone, an e-book reader, a desktop PC, a laptop PC, a netbook computer, a workstation, a server, and a personal digital assistants (PDA), a portable multimedia player (PMP), an MP3 player, a medical device, a camera, or a wearable device. The wearable device may include at least one of an accessory type (e.g., a watch, a ring, a bracelet, an anklet, a necklace, a glasses, a contact lens, or a head-mounted-device (HMD), a textile or clothing integral type (e.g., an electronic clothing), a body attachment type (e.g., a skin pad or a tattoo), or a bio-implantable type circuit.

In some embodiments, the electronic apparatus 100 may include, for example, at least one of a television, a digital video disk (DVD) player, a monitor, a display device, an audio device, a refrigerator, an air conditioner, a vacuum cleaner, an oven, a microwave oven, a washing machine, an air purifier, a set-top box, a home automation control panel, a security control panel, a media box (e.g., Samsung HomeSync™, Apple TV™ or Google TV™), a game console (e.g., Xbox™ or PlayStation™), an electronic dictionary, an electronic key, a camcorder, or an electronic picture frame.

The memory 110 may be implemented as internal memory such as ROM (e.g., electrically erasable programmable read-only memory (EEPROM)) or RAM, etc. included in the processor 120, or may be implemented as separate memory from the processor 120. In this case, the memory 110 may be implemented as memory embedded in the electronic apparatus 100 or as memory that can be attached or detached to and from the electronic apparatus 100 depending on the purpose of data storage. For example, in the case of data for driving the electronic apparatus 100, the data may be stored in the memory embedded in the electronic apparatus 100, and in the case of data for the expansion function of the electronic apparatus 100, the data may be stored in the memory detachable from the electronic apparatus 100.

The memory 110 may store an input image. The input image may include a plurality of frames.

The memory 110 may store first and second learning models that have the same network structure and estimate a motion between two frames. Here, the first learning model may be a model trained with image data having a first characteristic, for example, a model trained with image data including complex movements. The second learning model may be a model trained with image data having a second characteristic which is opposite to the first characteristic, for example, a model trained with image data including simple movements.

The memory 110 may store fourth and fifth learning models that have the same network structure and generate an interpolation frame having specific characteristics. Here, the fourth learning model may be a model trained to generate an interpolation frame having a third characteristic based on the estimated motion, for example, a model trained to generate an interpolation frame having a blurred characteristic. The fifth learning model may be a model trained to generate an interpolation frame having a characteristic that is different from the fourth learning model, for example, a model trained to generate an interpolation frame having a grainy characteristic.

Meanwhile, in the above, the first and second learning models trained based on the complexity or simplicity of the movements were used as examples, but in the implementation, two models trained with different characteristics that perform the same function may be used. In addition, the two learning models that generate an interpolation frame may also a model that generate an interpolation frame having characteristics of two extreme ends other than the blurred and grainy characteristics described above.

Meanwhile, in the case of the memory embedded in the electronic apparatus 100, the memory may be implemented as at least one of a volatile memory (e.g. a dynamic RAM (DRAM), a static RAM (SRAM), or a synchronous dynamic RAM (SDRAM)) or a non-volatile memory (e.g., a one-time programmable ROM (OTPROM), a programmable ROM (PROM), an erasable and programmable ROM (EPROM), an electrically erasable and programmable ROM (EEPROM), a mask ROM, a flash ROM, a flash memory (e.g. a NAND flash or a NOR flash), a hard drive, or a solid state drive (SSD)), and in the case of the memory detachable from the electronic apparatus 100, the memory may be implemented in the form of a memory card (e.g., a compact flash (CF), a secure digital (SD), a micro secure digital (Micro-SD), a mini secure digital (Mini-SD), an extreme digital (xD), or a multi-media card (MMC)), an external memory connectable to a USB port (e.g., a USB memory), or the like.

The processor 120 may perform overall control operations of the electronic apparatus 100. Specifically, the processor 120 functions to control the overall operation of the electronic apparatus 100.

The processor 120 may be implemented as a digital signal processor (DSP) for processing digital signals, a microprocessor, or a Time Controller (TCON). However, the processor 120 is not limited thereto, and may include one or more of a central processing unit (CPU), a Micro Controller Unit (MCU), a micro processing unit (MPU), a controller, an application processor (AP), a graphics-processing unit (GPU) or a communication processor (CP), and an advanced RISC machine (ARM) processor, or may be defined by the corresponding term. Further, the processor 120 may be implemented as a system-on-chip (SoC) or a large scale integration (LSI) in which a processing algorithm is embedded, or may be implemented in the form of a field programmable gate array (FPGA). In addition, the processor 120 may perform various functions by executing computer executable instructions stored in the memory.

The processor 120 may determine whether the generation of an interpolation frame is necessary. Specifically, the processor 120 may determine whether the generation of an interpolation frame is necessary based on the fps of the input image and the performance of the output image (or the frequency rate of the display). For example, when the electronic apparatus 100 includes a display, and the display is capable of operating at 120 fps, but the input image has a 60 hz, the processor 120 may be determined that the generation of an interpolation frame is necessary. Also, even in the case described above, the processor 120 may determine that the generation of an interpolation frame is necessary only when the user's upscaling (or generation of an interpolation frame) is set by the user's settings or the like.

When it is necessary to generate an interpolation frame, the processor 120 may determine at what rate the interpolation frame should be generated. For example, when the output at 120 fps is possible, but the input image is 60 fps, a double upscale is required, so the processor 120 may determine that one interpolation frame needs to be generated between the two frames.

Alternatively, when the at 120 fps is possible, but the input image is 40 fps, the processor 120 may determine that two interpolation frames need to be generated between the two frames.

The processor 120 may obtain as input frame(s) a first frame included in the input image and a second frame that is a previous frame to the first frame, and may generate an interpolation frame using the obtained first and second frames. As described above, the processor 120 may generate a single interpolation frame between the two frames, or may generate two or more interpolation frames.

Here, the input image may indicate an image stored in the memory 110, and the input image may include a plurality of frames. The first frame may refer to a current frame, and the second frame may refer to a previous frame. Here, the reference of the previous frame may be changed according to the user's setting, and if the reference of the previous frame is the frame immediately before the first frame, it may be the frame immediately preceding the first frame.

The processor 120 generates a third learning model using the first control parameter and the first and second learning models. Specifically, the processor 120 may generate a third learning model that has the same network structure as the first and second learning models, in which a plurality of nodes in the learning model have a weight value that is determined based on the first control parameter, a weight value of a corresponding node in the first learning model, and a weight value of a corresponding node in the second learning model. For example, the first control parameter may have a value between 0 and 1, and the processor 120 may generate a third learning model having a weight value of each of a plurality of nodes in the third learning model as a sum of a value obtained by multiplying a weight value of a corresponding node in the second learning model by 1 minus the first control parameter and a value obtained by multiplying a weight value of a corresponding node in the first learning model by the first control parameter.

The processor 120 estimates a motion between the first frame and the second frame using the generated third learning model.

Subsequently, the processor 120 generates an interpolation frame based on the estimated motion. Specifically, the processor 120 may generate a sixth learning model using the second control parameter, the fourth learning model, and the fifth learning model. For example, the processor 120 may generate a sixth learning model that has the same network structure as the fourth and fifth learning models, in which a weight value of a plurality of nodes in the learning model is determined based on based on the second control parameter, a weight value of a corresponding node in the fourth learning model, and a weight values of a corresponding node in the fifth learning model.

Subsequently, the processor 120 may generate an interpolation frame using the estimated motion and the sixth learning model.

Meanwhile, the third learning model and the sixth learning model described above may be used at each time when interpolation of each frame is required, and may be initially generated at the time when interpolation is required and updated and used only when an interpolation parameter is changed. In other words, when the first parameter initially has a value of 0.5, the processor 120 may generate the third learning model using the first control parameter, the first learning model, and the second learning model, and estimate the motion (or movement) using the generated third learning model. Then, when the first control parameter is subsequently updated (e.g., when the user modifies the parameter value, or when the characteristics of the image change, etc.), a third learning model may be newly generated to estimate a motion based on the changed (or updated) parameter.

The electronic apparatus 100 as described above may operate adaptively to various characteristics as it generates and uses learning models adaptively to various characteristics using two learning models trained with different characteristics while performing the same function. In addition, since a model trained with all characteristics is not used, it is possible to use a lighter learning model, and faster training is possible in the training process.

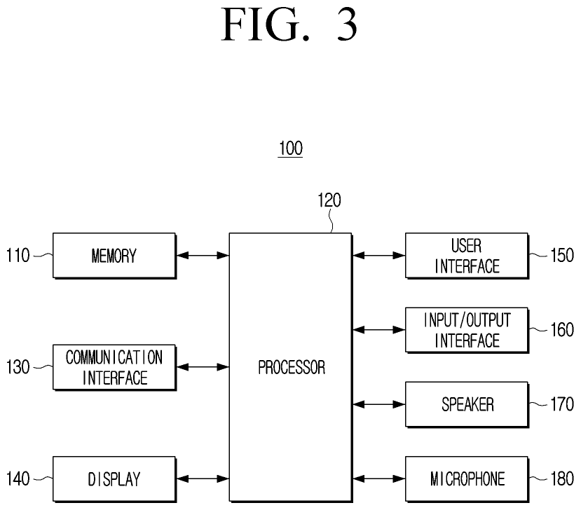

Meanwhile, in the above, only a simple configuration of the electronics 100 has been shown and described, but in the implementation, various configurations may be further provided. This will be described below with reference to FIG. 3.

FIG. 3 is a block diagram illustrating configuration of an electronic apparatus according to an embodiment.

Referring to FIG. 3, the electronic apparatus 100 may include the memory 110, the processor 120, a communication interface 130, a display 140, a user interface 150, an input/output interface 160, a speaker 170, and a microphone 180.

Meanwhile, operations of the memory 110 and processor 120 that are identical to those described above will not be redundantly described.

Meanwhile, the processor 120 may perform a graphic processing function (a video processing function). For example, the processor 120 may generate a screen including various objects such as an icon, an image, a text, etc. using an operator (not illustrated) and a renderer (not illustrated). Here, the operator (not illustrated) may operate attribute values such as coordinate values, forms, sizes, and colors of each object to be represented according to a layout of the screen based on the received control instruction. The renderer (not illustrated) may generate screens of various layouts including the objects based on the attribute values which are operated by the operator (not illustrated). In addition, the processor 120 may perform various image processing such as decoding, scaling, noise filtering, frame rate conversion, resolution conversion, etc. with respect to video data.

Meanwhile, the processor 120 may perform various processing with respect to audio data. Specifically, the processor 120 may perform various processing such as decoding, amplification, noise filtering with respect to audio data.

The communication interface 130 is configured to perform communication with various types of external devices according to various types of communication methods. The communication interface 130 may include a Wi-Fi module, a Bluetooth module, an infrared communication module, a wireless communication module, etc. Here, each communication module may be implemented in the form of at least one hardware chip.

The Wi-Fi module and the Bluetooth module perform communication in a Wi-Fi method and a Bluetooth method, respectively. In case of using the Wi-Fi module and the Bluetooth module, various connection information such as a service set identifier (SSID) and a session key may be first transmitted and received to establish communication connection, and then various information may be transmitted and received.

The infrared communication module performs communication according to an infrared Data Association (IrDA) technology using infrared light which lies between visible light and millimeter waves for short-distance wireless data transmission.

The wireless communication module, comprising communication circuitry, may include at least one communication chip that performs communication according to various wireless communication standards such as Zigbee, 3rd generation (3G), 3rd generation partnership project (3GPP), long term evolution (LTE), LTE Advanced (LTE-A), 4th generation (4G), and 5th generation (5G), other than the above-described communication methods.

In addition, the communication interface 130 may include at least one of a wired communication modules that perform communication using a local area network (LAN) module, an Ethernet module, a pair cable, a coaxial cable, an optical fiber cable, a UWB (Ultra Wide-Band) module, etc. Each “module” herein may comprise circuitry.

According to an embodiment, the communication interface 130 may use the same communication module (e.g., a Wi-Fi module) to perform communication with an external device such as a remote controller and an external server.

According to another embodiment, the communication interface 130, comprising communication circuitry, may use different communication modules (e.g., a Wi-Fi module) to perform communication with an external device such as a remote controller and an external server. For example, the communication interface 130 may use at least one of an Ethernet module or a Wi-Fi module to perform communication with an external server, and may also use a BT module to perform communication with an external device such as a remote controller. However, this is only one embodiment, and the communication interface 130 may use at least one of various communication modules when performing communication with a plurality of external devices or external servers.

The display 140 may be implemented as various types of displays such as a Liquid Crystal Display (LCD), an Organic Light Emitting Diodes (OLED) display, a Plasma Display Panel (PDP), and the like. The display 140 may also include a driving circuit, a backlight unit, and the like, which may be implemented in the form of a-si TFTs, low temperature poly silicon (LTPS) TFTs, organic TFTs (OTFTs), and the like. Meanwhile, the display 140 may be implemented as a touch screen combined with a touch sensor, a flexible display, a 3D display, and the like.

The display 140 may generate an output image generated in the preceding process. Specifically, the display 140 may display an output image having the order of the second frame, the interpolation frame, and the first frame.

Further, according to an embodiment, the display 140 may include not only a display panel for outputting images, but also a bezel housing the display panel. In particular, according to an embodiment, the bezel may include a touch sensor (not shown) for detecting a user interaction.

The user interface 150 may be implemented as a button, a touch pad, a mouse, a keyboard, etc., or may be implemented as a touch screen that can also perform a display function and a manipulation input function. Here, the button may be various types of buttons such as mechanical buttons, touch pads, wheels, etc. formed on any area of the exterior of the main body of the electronic apparatus 100, such as the front, side, or back.

The input/output interface 160 may be one of High Definition Multimedia Interface (HDM), Mobile High-Definition Link (MHL), Universal Serial Bus (USB), Display Port (DP), Thunderbolt, Video Graphics Array (VGA) port, RGB port, D-subminiature (D-SUB), or Digital Visual Interface (DVI).

The input/output interface 160 may input/output at least one of audio or video signals.

Depending on an implementation example, the input/output interface 160 may include a port that inputs/outputs only audio signals and a port that inputs/outputs only video signals as separate ports, or may be implemented as a single port that inputs/outputs both audio and video signals.

The electronic apparatus 100 may include the speaker 170. The speaker 170 may be a component that outputs not only various audio data processed by the input/output interface but also various notification sounds, voice messages, etc.

The electronic apparatus 100 may further include the microphone 180. The microphone is configured to receive a user voice or other sound and convert it into audio data.

The microphone 180 may receive a user voice in an activated state. For example, the microphone 180 may be formed as an integral part of the top, front, side, etc. of the electronic apparatus 100. The microphone 180 may include various configurations, such as a microphone to collect sound in an analog form, an amplifier circuit to amplify the collected sound, an A/D conversion circuit to sample and convert the amplified sound to a digital signal, a filter circuit to remove noise components from the converted digital signal, and the like.

Meanwhile, according to an embodiment, the electronic apparatus 100 may include a display, and may display an image on the display.

According to another embodiment, the electronic apparatus 100 may be implemented in the form of a device that does not include a display, or may include only a simple display for notifications, etc. Further, the electronic apparatus 100 may be implemented in a form that transmits images to a separate display device via a video/audio output port or a communication interface.

Meanwhile, the electronic apparatus 100 may have a port for simultaneously transmitting or receiving video and audio signals. According to another embodiment, the electronic apparatus 100 may have a port for transmitting or receiving video and audio signals separately.

Meanwhile, the interpolation operation may be performed in one of the electronic apparatus 100 or an external server. In one example, the interpolation operation may be performed in an external server to generate an output image, and the electronic apparatus 100 may receive and display the output image from the external server.

As another example, the electronic apparatus 100 may directly perform the interpolation operation to generate an output image, and display the generated output image.

In another example, the electronic apparatus 100 may directly perform the interpolation operation to generate an output image, and transmit the generated output image to an external display device. Here, the external display device may receive the output image from the electronic apparatus 100 and display the received output image.

FIG. 4 is a view provided to explain a deep learning-based frame interpolation technique according to an embodiment.

Referring to FIG. 4, an interpolation technique according to the present disclosure is divided into a first operation for estimating a motion between two frames and a second operation for generating an interpolated image with the estimated motion, and the two operations operate using different learning models.

First, a first operation 210 performs the operation of estimating a motion (F_{0->1}, F_{1->0}) of an image using two images (Iₒ, I₁). Specifically, the third learning model that estimates a motion between two frames may be used. Here, the third learning model may be a learning model generated using the first and second learning models that have the same network structure and estimate a motion between two frames and the first parameter.

Specifically, when the interpolation of an image is required, the first parameter may be input (or set) by the user, or the first parameter corresponding to the characteristics of the image may be selected. For example, a lookup table for each type of image may be used, with a value of 0.9 for a sports image and a value of 0.1 for a drama.

Furthermore, the first parameter described above may be fixedly used as the initially set value, and may be updated according to specific conditions. For example, the motion estimation and interpolation described above are performed continuously with respect to an image. Therefore, by analyzing the previously generated interpolation frame, it is possible to analyze whether the first parameter currently in use is an appropriate value for the current image, and update the first parameter corresponding to the analysis result.

Once the first parameter is determined through the process described above, the first learning model and the second learning model may be linearly interpolated using the determined first parameter to generate the third learning model. The specific operation of the linear interpolation will be described below with reference to FIGS. 5 and 6.

Next, a second operation 220 performs the operation of generating an interpolation frame (or interpolated image) (Iₜ) with the estimated motion (F_{0->1}, F_{1->0}). Specifically, the sixth learning model that generates an interpolated image with two frames and the estimated motion may be used. Here, the sixth learning model may be a learning model generated using the fourth and fifth learning models that have the same network structure and are trained to have different characteristics and the second parameter.

As described earlier, the second parameter may be used as the initially set value set, or may be updated based on the conditions of the image or the analysis results of the generated interpolated image.

FIG. 5 is a view provided to explain an interpolation operation of a network model according to an embodiment. Specifically, the operation of generating a learning model having new characteristics by linearly interpolating two learning models with the same function but different characteristics will be described.

Referring to FIG. 5, two network models (learning models) 510, 520 are illustrated. The first learning model is a model trained with training data having a first characteristic (e.g., the first learning model described above) or a model trained to have an output of a fourth characteristic (e.g., the fourth learning model described above).

The second learning model is a model trained with training data that has a second characteristic which is opposite to the first characteristic, or a model trained to have an output with a fifth characteristic (e.g., the fifth learning model described above).

In general, a learning model is trained to perform a specific function in response to an input and generate an output that matches the function. However, if the same function but different characteristics must be output, different learning is required even if the internal structure of the learning model is the same. As a result, in order to continuously output results having continuous characteristics, a considerable number of learning models have to be trained for each characteristic.

For example, when it is assumed that the case where the movement is very complex is 1 and the case where the movement is very simple is 0, in order to cover various cases, a learning model has to be trained using all data corresponding to cases of 0, 0.1, . . . 0.9, 1.

In other words, the method of using a learning model for image quality processing shows superior performance compared to the conventional method, but due to high computational complexity and memory, a lightweight model must be used for commercialization. However, a lightweight AI model often does not show good performance for inputs with various characteristics, and to solve this problem, it is common to train a network for each characteristic and keep each network parameter in memory. This method significantly increases the memory for storing network parameters, and when there are many characteristics, the training time is also significant.

To overcome this problem, the present disclosure uses two learning models that perform the same function, but are trained with a control parameter and characteristics at both ends of the control parameter when the characteristics can be changed linearly.

Subsequently, when used, the two learning models are linearly interpolated using a control parameter (α) to generate a new learning model.

As described above, the two learning models have the same network structure. Therefore, a new learning model 530 may be generated by calculating a weight value of each node in each network structure as α*θ_{A}+(1−α)*θ_{B}, (here, θ_{A} is the weight value of the corresponding node in the first learning model 510 and θ_{B} is the weight value of the corresponding node in the second learning model). Such linear interpolation will be described in greater detail below with reference to FIG. 6.

FIG. 6 is a view provided to explain a detailed operation of an interpolation operation of a network model according to an embodiment.

Referring to FIG. 6, a first learning model 610 and a second learning model 620 have the same network structure. For simplicity of illustration, a network structure with three layers and only seven nodes is illustrated, but in implementation, the learning model may include more layers and more nodes.

In this way, a case is described where the first learning model 610 and the second learning model 620 are used to generate a third learning model 630 having a first parameter.

The new third learning model has the same network structure as the first learning model and the second learning model, and the weight value of each node in the third learning model may be calculated as the weight value of the node in the corresponding first learning model and the weight value of the node in the second learning model. For example, as illustrated in the drawing, the weight value of node C can be calculated as the weight value of node (A) at the same location of the same first learning model and the weight value of node (β) at the same location of the second learning model.

When the current input image has a lot of movements and thus, the value of the first control parameter (α) is 1, the generated third learning model will have the same weight value as the first learning model. Conversely, when the current input image has few movements and thus, the value of the first control parameter (α) is 0, the generated third learning model will have the same weight value as the second learning model.

When the current input image has moderate movements, and thus, the value of the first control parameter (α) is between 0 and 1, each node of the generated third learning model has a weight value according to the above calculation.

By using the proposed method, only two types of learning models are generated and used for continuous characteristics, which has the advantage of reducing memory and training time compared to the existing method.

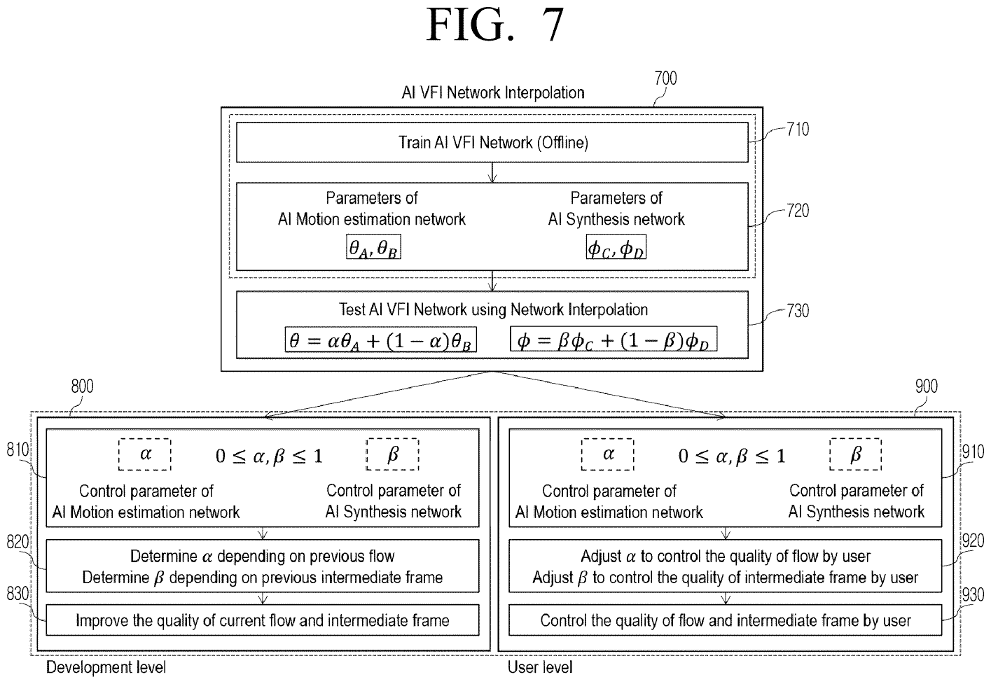

FIG. 7 is a view illustrating detailed configuration of a processor according to an embodiment.

Referring to FIG. 7, an interpolation system 700 according to the present disclosure is illustrated. Such a system may be implemented as a plurality of electronic apparatuses, and may be operated by a single processor within a single electronic apparatus, or by a plurality of processors within a single electronic apparatus.

An interpolation module 700 is a system to which an AI VFI network such as that of FIG. 4 or FIG. 5 is applied.

The interpolation module 700 may include a module 710 for storing a learning model, a module 720 for determining a parameter, and a linear interpolation module 730.

The module 710 for storing a learning model is a module for storing a learning model for applying the network interpolation technique of the AI VFI Network according to the present disclosure, which may be implemented as memory or the like.

The module 720 for determining a parameter is a module for determining an interpolation parameter to be used during linear interpolation of two learning models. In the illustrated example, different learning models are used in each of the steps of estimating a motion and generating an interpolation frame using the estimated motion, so four parameters are illustrated, but in implementation, the present disclosure may be applied only when estimating a motion, or only in the process of generating an interpolated image using the estimated motion.

The linear interpolation module 730 is a module that linearly interpolates learning models of two characteristics to generate a learning model to be applied to a specific operation. Specifically, the linear interpolation module 730 may generate a new learning model that can generate a result of an arbitrary characteristic between two characteristics through linear interpolation of the learning models of the branch characteristics. This makes it possible for the AI VFI network to adaptively operate to various characteristics.

A developer model 800 is a model for utilizing the interpolation system 700 described above at the developer level.

Such a developer model 800 may include a control parameter adjustment module 810, a control parameter determination module 820, and an output module 830.

The control parameter adjustment module 810 is a module for flexibly adjusting the results of the AI VFI Network.

The control parameter determination module 820 is a module for determining a control parameter to generate good quality results of the AI VFI Network.

The output module 830 is a module that generates and outputs an interpolation frame corresponding to the current frame based on the determined control parameter.

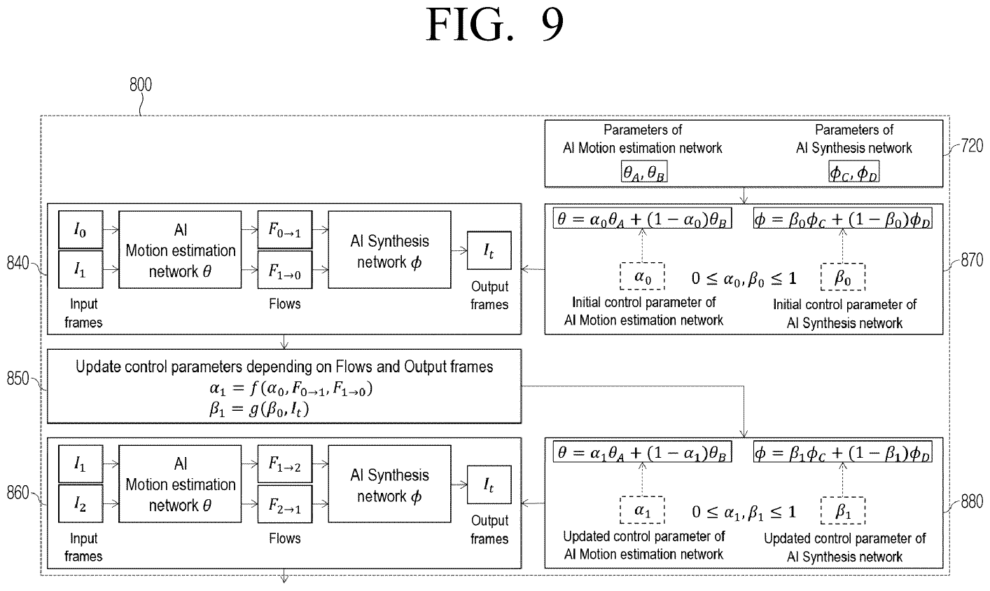

The specific configuration and operation of the developer module 800 will be described below with reference to FIG. 9.

A usage module 900 is a module for utilizing the interpolation system 700 described above at the user level.

A usage module 900 may include a control parameter adjustment module 910, an input module 920, and an output module 930.

The control parameter adjustment module 910 is a module that determines a control parameter for flexibly adjusting the results of the AI VFI Network.

The input module 920 is a module that receives a control parameter from the user.

The output module 930 is a module that generates a learning model to be used when estimating a motion or generating an interpolated frame using an input or determined control parameter and a pre-trained learning model, and generates and outputs an interpolated frame using the generated learning model.

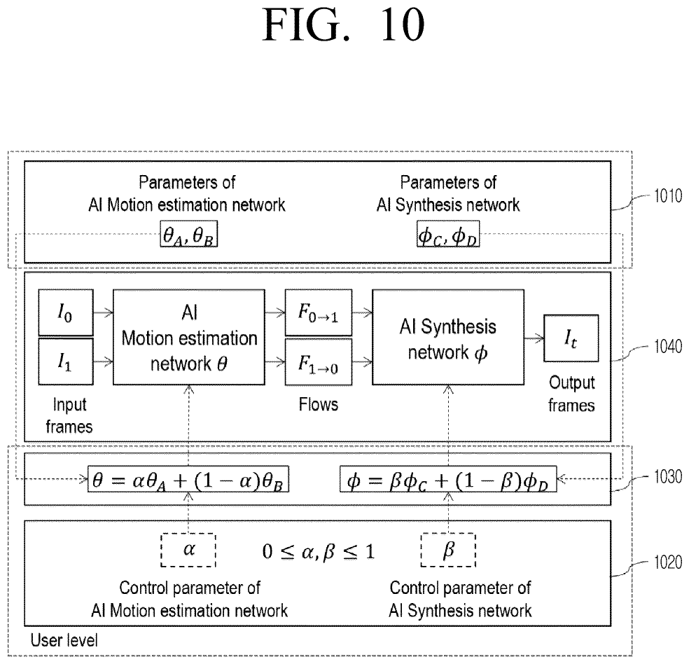

The specific configuration and operation of a usage module 200 will be described below with reference to FIG. 10.

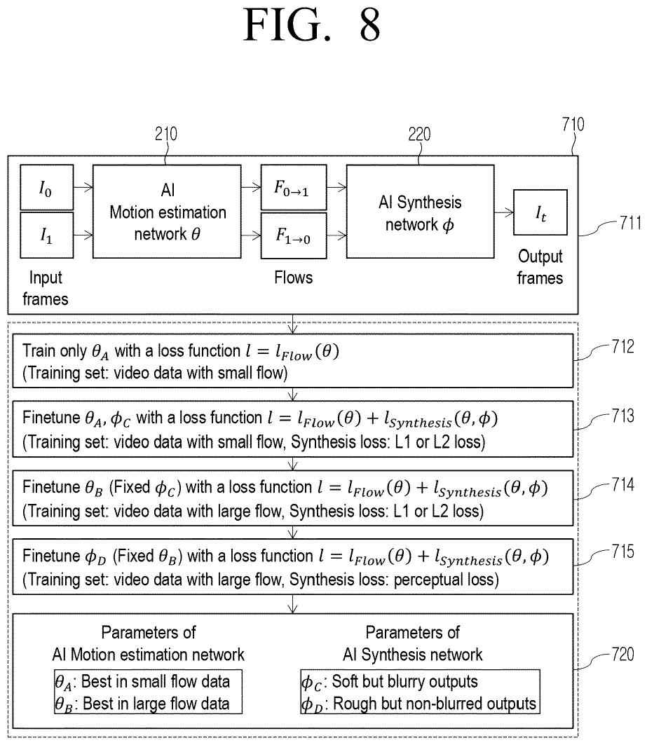

FIG. 8 is a view provided to explain a learning operation of a learning model according to an embodiment. The view is to explain the operation of generating two learning models with different characteristics according to the present disclosure.

Referring to FIG. 8, the interpolation module 700 may include a network generation module 711.

Specifically, the interpolation method according to the present disclosure is divided into an operation of estimating a motion and an operation of generating an interpolated image based on the estimated motion, and different models are used for each operation. Accordingly, the network generation module 711 may generate two first and second learning models for motion estimation, and two fourth and fifth learning models for generating an interpolated image. Here, the first learning model and the second learning model may have the same network structure, and the fourth learning model and the fifth learning model may also have the same network structure. Here, having the same network structure may indicate having the same number of layers and the same node structure, and the weight values in each node may be different from each other.

As such, when learning models are generated, at first, only the first learning model may be trained with flow loss for the image data of the first characteristic (small flow) to ensure that the first learning model (θ_{A}) performs well with respect to the first characteristic (small flow data) (712).

Subsequently, in order to ensure that the interpolation frame generated by the fourth learning model (θ_{C}) is smooth but blurry in image quality, the entire network including the network trained in the previous step and the AI synthesis network may be trained with flow loss and synthesis loss (713). In this case, the synthesis loss uses either L1 or L2 loss.

Then, in order to ensure that the second learning model (θ_{B}) performs well with respect to the second characteristic (large flow data), for the image data of the second characteristic (large flow), the entire network is trained with flow loss and synthesis loss (714). In this case, the synthesis loss is either L1 or L2 loss, and the fourth learning model (θ_{C}) is trained in a fixed state.

Subsequently, in order to ensure that the interpolation frame generated by the fifth learning model (θ_{D}) is grainy but not blurry, it is trained with flow loss and synthesis loss from the entire network trained in the previous step (715). In this case, the synthesis loss uses the perceptual loss, and the second learning model (θ_{B}) is trained in a fixed state (715).

Through the process described above, four learning models may be generated (720).

FIG. 9 is a view provided to explain an operation of adjusting a control parameter in a development process according to an embodiment.

The parameter determining module 720 may store four learning models trained by the training process shown in FIG. 8. Specifically, the first learning model (θ_{A}) is a model specialized for the first characteristic (small flow), and the second learning model (θ_{B}) is a model specialized for the second characteristic (large flow data), which is opposite to the first characteristic. These two first and second learning models can be used for flow data of various sizes.

The fourth learning model (θ_{C}) is a model trained to generate results having the fourth characteristic (sofe), and the fifth learning model (θ_{D}) is a model trained to generate results having the fifth characteristic (grainy), which is opposite to the fourth characteristic.

An initial parameter determination module 870 generates the third learning model and the sixth learning model using two parameters (α, β) that are initially set as default. Here, the first control parameter (α) is a control parameter used to generate the third learning model (θ_{A}) using the first learning model (θ_{A}) and the second learning model (θ_{B}), and the second control parameter (β) is a control parameter used to generate the sixth learning model (Φ) using the fourth learning model (θ_{C}) and the fifth learning model (θ_{D}).

An interpolation module 840 is a module that estimates a motion using the third learning model generated by the two control parameters generated by the initial parameter determination module 870, or generates an interpolation frame using the sixth learning model.

A parameter update module 850 is a module that newly determines and updates the first and second control parameters (α, β) using the interpolated image generated by the interpolation module (840). Specifically, the first parameter may be updated based on the size of the maximum value of the flow obtained from the previous frame. Subsequently, the second parameter (β) value may be updated based on the degree of the characteristic (blurriness) value of the interpolation frame obtained from the previous frame.

A second interpolation module 860 is a module that generates an interpolation frame using the updated control parameters.

Subsequently, the control parameter update operation 880 and the interpolation frame generation operation 860 described above may be performed repeatedly.

Once the control parameters have converged to a certain value through the process described above, it is possible to determine the initial parameter to be used for each image. The initial parameter determined in this way may be stored in the memory of the electronic apparatus 100 as a lookup table or the like. In addition, the above-described value may be updated by updating the firmware or the like.

FIG. 10 is a view provided to explain an operation of adjusting a control parameter in an interpolation process according to an embodiment.

A parameter determination module 1010 may store four learning models trained by the training process shown in FIG. 8. Specifically, the first learning model (θ_{A}) is a model specialized for the first characteristic (small flow), and the second learning model (θ_{B}) is a model specialized for the second characteristic (large flow data) which is opposite to the first characteristic. These two first and second learning models may be used for flow data of different sizes.

A control parameter adjustment module 1020 is a module that receives the first control parameter and/or the second control parameter described above. These first control parameters and second control parameters may be input directly from the user, or predetermined values may be used based on characteristics of the current image.

For example, when the first control parameter (α) is close to 0, it may operate as a model specialized for images with large motions, and when the first control parameter (α) is close to 1, it may operate as a model specialized for images with small motions.

When the second parameter (β) is close to 0, it may operate to generate a rough but non-blurred interpolated image, and when the second parameter (β) is close to 1, it may operate to generate a smooth but blurry interpolated image.

A linear interpolation module 1030 is a module that generates the third learning model or the sixth learning model using the previously determined control parameters.

An output module 1040 is a model that uses the input or determined parameters to finally generate a learning model, and outputs an interpolation frame with the generated learning model.

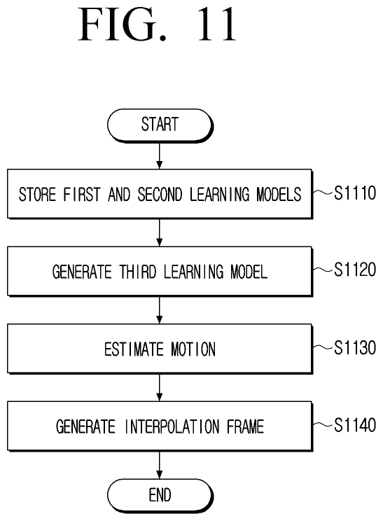

FIG. 11 is a view provided to explain a controlling method of an electronic apparatus according to an embodiment.

Referring to FIG. 11, first, the first and second learning models having the same network structure and estimating a motion between two frames are stored (S1110). Here, the first learning model is a model trained with image data having the first characteristic, and the second learning model is a model trained with image data having the second characteristic opposite to the first characteristic. In addition, the electronic apparatus may further store the fourth learning model trained to generate an interpolation frame having the third characteristic based on the estimated motion, and the fifth learning model trained to generate an interpolation frame having the same network structure as the fourth learning model and having the fourth characteristic opposite to the third characteristic.

Subsequently, the first frame included in the input image and the second frame, which is the previous frame of the first frame, are obtained, and an interpolation frame is generated using the obtained first and second frames.

Specifically, the third learning model is generated using the first control parameter and the first and second learning models (S1120). More specifically, the third learning model having the same network structure as the first and second learning models, in which a plurality of nodes are determined based on the first control parameter, a weight value of a corresponding node in the first learning model and a weight value of a corresponding node in the second learning model, may be generated. For example, the first control parameter has a value between 0 and 1, and the third learning model having a weight value of each of a plurality of nodes in the third learning model as a sum of a value obtained by multiplying a weight value of a corresponding node in the second learning model by 1 minus the first control parameter and a value obtained by multiplying a weight value of a corresponding node in the first learning model by the first control parameter may be generated.

In this case, the first parameter used in the process of generating the learning model described above may be input from the user, may be determined by checking an image property of the input image and determining the first control parameter corresponding to the checked image property, or may be determined by checking an image property of the generated interpolation frame and using a parameter corresponding to the checked image property.

The generated third learning model is then used to estimate a motion between the first frame and the second frame (S1130).

Subsequently, an interpolation frame is generated based on the estimated motion (S1140).

Specifically, the second control parameter, the fourth learning model, and the fifth learning model may be used to generate the sixth learning model, and the estimated motion and the sixth learning model may be used to generate an interpolation frame. Specifically, the sixth learning model having the same network structure as the fourth and fifth learning models, in which a weight value of a plurality of nodes in the learning model is determined based on the second control parameter, a weight value of a corresponding node in the fourth learning model and a weight value of a corresponding node in the fifth learning model, may be generated. “Based on” as used herein covers based at least on.

An output image having the order of the second frame, the interpolation frame, and the first frame may be generated. The output image may be displayed, or transmitted to another device.

Meanwhile, according to an embodiment, the above-described various embodiments may be implemented as software including instructions stored in machine-readable storage media, which can be read by machine (e.g.: computer). The machine refers to a device that calls instructions stored in a storage medium, and can operate according to the called instructions, and the device may include a display device (e.g., electronic apparatus A) according to the aforementioned embodiments. In case an instruction is executed by a processor, the processor may perform a function corresponding to the instruction by itself, or by using other components under its control. The instruction may include a code that is generated or executed by a compiler or an interpreter. The machine-readable storage medium may be provided in the form of a non-transitory storage medium. Here, the term ‘non-transitory’ means that the storage medium is tangible without including a signal, and does not distinguish whether data are semi-permanently or temporarily stored in the storage medium.

In addition, according to an embodiment, the above-described methods according to the various embodiments may be included and provided in a computer program product. The computer program product may be traded as a product between a seller and a purchaser. The computer program product may be distributed in a form of a storage medium (e.g., a compact disc read only memory (CD-ROM)) that may be read by the machine or online through an application store (e.g., PlayStore™). In case of the online distribution, at least a portion of the computer program product may be at least temporarily stored in a storage medium such as a memory of a server of a manufacturer, a server of an application store, or a relay server or be temporarily generated.

Meanwhile, the above-described various embodiments may be implemented in a recording medium that can be read by a computer or a similar device using software, hardware, or a combination thereof. In some cases, embodiments described herein may be implemented by a processor itself. According to software implementation, embodiments such as procedures and functions described in this specification may be implemented as separate software. Each software may perform one or more functions and operations described in this disclosure.

Meanwhile, computer instructions for performing processing operations of the robot device according to the above-described various embodiments may be stored in a non-transitory computer-readable medium. When being executed by a processor of a specific device, the computer instructions stored in such a non-transitory computer-readable medium allows the specific device to perform processing operations in the electronic apparatus according to the above-described various embodiments. The non-transitory computer-readable medium refers to a medium that stores data semi-permanently and can be read by a device, rather than a medium that stores data for a short period of time, such as registers, caches, memory, etc. Specific examples of the non-transitory computer-readable medium may include CD, DVD, hard disk, Blu-ray disk, USB, memory card, ROM, etc.

Further, the components (e.g., modules or programs) according to various embodiments described above may include a single entity or a plurality of entities, and some of the corresponding sub-components described above may be omitted or other sub-components may be further included in the various embodiments. Alternatively or additionally, some components (e.g., modules or programs) may be integrated into one entity and perform the same or similar functions performed by each corresponding component prior to integration. Operations performed by the modules, the programs, or the other components according to the various embodiments may be executed in a sequential manner, a parallel manner, an iterative manner, or a heuristic manner, or at least some of the operations may be performed in a different order or be omitted, or other operations may be added.

Although preferred embodiments of the present disclosure have been shown and described above, the disclosure is not limited to the specific embodiments described above, and various modifications may be made by one of ordinary skill in the art without departing from the gist of the disclosure as claimed in the claims, and such modifications are not to be understood in isolation from the technical ideas or prospect of the disclosure.

While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

1. An electronic apparatus comprising:
memory storing first and second learning models, each with the same network structure, and configured to estimate a motion between two frames; and
at least one processor, comprising processing circuitry, individually and/or collectively configured to obtain a first frame included in an input image and a second frame which is a previous frame of the first frame, and generate an interpolation frame using the obtained first frame and second frame,
wherein the first learning model is a model configured to be trained with image data having a first characteristic;
wherein the second learning model is a model configured to be trained with image data having a second characteristic which is opposite to the first characteristic; and
wherein the at least one processor is individually and/or collectively configured to generate a third learning model using a first control parameter and the first and second learning models, estimate a motion between the first frame and the second frame using the generated third learning model, and generate the interpolation frame based on the estimated motion.

2. The device as claimed in claim 1, wherein the at least one processor is individually and/or collectively configured to generate the third learning model which has the same network structure as the first and second learning models, in which a plurality of nodes in the third learning model has a weight value that is determined based on the first control parameter, a weight value of a corresponding node in the first learning model and a weight value of a corresponding node corresponding in the second learning model.

3. The device as claimed in claim 2, wherein the first control parameter has a value between 0 and 1; and
wherein the at least one processor is individually and/or collectively configured to generate the third learning model having a weight value of each of a plurality of nodes in the third learning model as a sum of a value obtained at least by multiplying a weight value of a corresponding node in the second learning model by 1 minus the first control parameter and a value obtained by multiplying a weight value of a corresponding node in the first learning model by the first control parameter.

4. The device as claimed in claim 1, wherein the memory is configured to store a fourth learning model trained to generate an interpolation frame having a third characteristic based on an estimated motion and a fifth learning model which has the same network structure as the fourth learning model and is trained to generate an interpolation frame having a fourth characteristic which is opposite to the third characteristic; and
wherein the at least one processor is individually and/or collectively configured to generate a sixth learning model using a second control parameter, the fourth learning model and the fifth learning model, and generate an interpolation frame using the estimated motion and the sixth learning model.

5. The device as claimed in claim 4, wherein the at least one processor is individually and/or collectively configured to generate the sixth learning model which has the same network structure as the fourth and fifth learning models, in which a weight value of a plurality of nodes in the sixth learning model is determined based on the second control parameter, a weight value of a corresponding node in the fourth learning model and a weight value of a corresponding node corresponding in the fifth learning model.

6. The device as claimed in claim 4, wherein the first learning model is a model trained with image data having complex movements;
wherein the second learning model is a model trained with image data having simple movements;
wherein the fourth learning model is a model trained to generate an interpolation frame having a blurred characteristic; and
wherein the fifth learning model is a model trained to generate an interpolation frame having a grainy characteristic.

7. The device as claimed in claim 1, further comprising:
an input/output interface, comprising circuitry, configured to input the first control parameter,
wherein the at least one processor is individually and/or collectively configured to generate the third learning model using the input first parameter.

8. The device as claimed in claim 1, wherein the at least one processor is individually and/or collectively configured to identify an image characteristic of the input image, determine the first control parameter corresponding to the identified image characteristic, and generate the third learning model using the determined first control parameter.

9. The device as claimed in claim 1, wherein the at least one processor is individually and/or collectively configured to identify an image characteristic of the generated interpolation frame, and update the first control parameter to a parameter corresponding to the identified image characteristic.

10. The device as claimed in claim 1, further comprising:
a display,
wherein the at least one processor is individually and/or collectively configured to control the display to display an image in the order of the second frame, the interpolation frame and the first frame.

11. A controlling method of an electronic apparatus, the method comprising:
storing first and second learning models which have the same network structure and estimate a motion between two frames;
obtaining a first frame included in an input image and a second frame which is a previous frame of the first frame; and
generating an interpolation frame based on the obtained first frame and second frame,
wherein the first learning model is a model trained with image data comprising a first characteristic as image data,
wherein the second learning model is a model trained with image data comprising a second characteristic which is opposite to the first characteristic, and
wherein the generating the interpolation frame comprises:
generating a third learning model based on a first control parameter and the first and second learning models;
estimating a motion between the first frame and the second frame using the generated third learning model; and
generating the interpolation frame based on the estimated motion.

12. The method as claimed in claim 11, wherein the generating a third learning model comprises generating the third learning model which has the same network structure as the first and second learning models, and has a weight value in which a plurality of nodes in the third learning model are determined based on the first control parameter, a weight value of a corresponding node in the first learning model and a weight value of a corresponding node corresponding in the second learning model.

13. The method as claimed in claim 12, wherein the first control parameter has a value between 0 and 1; and
wherein the generating a third learning model comprises generating the third learning model having a weight value of each of a plurality of nodes in the third learning model as a sum of a value obtained by multiplying a weight value of a corresponding node in the second learning model by 1 minus the first control parameter and a value obtained by multiplying a weight value of a corresponding node in the first learning model by the first control parameter.

14. The method as claimed in claim 11, wherein the storing comprises further storing a fourth learning model trained to generate an interpolation frame having a third characteristic based on an estimated motion and a fifth learning model which has the same network structure as the fourth learning model and is trained to generate an interpolation frame having a fourth characteristic which is opposite to the third characteristic; and
wherein the generating the interpolation frame comprises:
generating a sixth learning model using a second control parameter, the fourth learning model and the fifth learning model;
generating an interpolation frame using the estimated motion and the sixth learning model.

15. A non-transitory computer-readable recording medium storing a program for executing a controlling method of an electronic apparatus, the method comprising:
storing first and second learning models which have the same network structure and estimate a motion between two frames;
obtaining a first frame included in an input image and a second frame which is a previous frame of the first frame; and
generating an interpolation frame using the obtained first frame and second frame,
wherein the first learning model is a model trained with image data having a first characteristic as image data;
wherein the second learning model is a model trained with image data having a second characteristic which is opposite to the first characteristic; and
wherein the generating the interpolation frame comprises:
generating a third learning model using a first control parameter and the first and second learning models;
estimating a motion between the first frame and the second frame using the generated third learning model; and
generating the interpolation frame based on the estimated motion.
